(19) United States
(12) Patent Application Publication
(10) Pub. No.: US 2025/0046552 A1
(43) Pub. Date: Feb. 6, 2025

(54) ELECTRIC CIRCUIT BREAKER DEVICE

(71) Applicant: Daicel Corporation, Osaka-shi, Osaka (JP)

(72) Inventors: Tomohide FUJIWARA, Tokyo (JP); Yutaka SATO, Tokyo (JP); Yuya KAIGA, Tokyo (JP); Katsuhiro NAKAHASHI, Tokyo (JP)

(73) Assignee: Daicel Corporation, Osaka-shi, Osaka (JP)

(21) Appl. No.: 18/836,005

(22) PCT Filed: Sep. 30, 2022
(86) PCT No.: PCT/JP2022/036837

§ 371 Date: Aug. 6, 2024

(30) Foreign Application Priority Data
Feb. 10, 2022 (JP) 2022-019853

(51) Int. Cl. H01H 39/00

(52) U.S. Cl. CPC H01H 39/006; H01H 2039/008

(57) ABSTRACT

An electric circuit breaker device including a housing serving as an outer shell member, the housing configured to enclose an accommodation space extending in one direction, an igniter provided in the housing, a projectile disposed in the housing, the projectile being configured to be projected from one end side of the accommodation space by energy received from the igniter, the projectile being configured to move along an extending direction of the accommodation space, and a conductor piece held by the housing, the conductor piece forming a part of an electric circuit, the conductor piece including a cutoff portion between a first connection end portion as one end portion and a second connection end portion as the other end portion, the cutoff portion being configured to be cut off by movement of the projectile, the cutoff portion being disposed across the accommodation space.

### TECHNICAL FIELD

The present invention relates to an electric circuit breaker device.

### BACKGROUND ART

Typically, there has been proposed an electric circuit breaker device including an igniter provided in a housing, a projectile disposed in a tubular space formed in the housing, the projectile being movably formed in the tubular space by energy received from the igniter, a conductor piece provided to the housing, the conductor piece forming a part of an electric circuit, the conductor piece including a cutoff portion configured to be cut off by the projectile at a part of the conductor piece, the conductor piece being disposed with the cutoff portion crossing the tubular space, an arc-extinguishing region located within the tubular space, on a side opposite to the projectile before actuation of the igniter with the cutoff portion interposed between the arc-extinguishing region and the projectile, the arc-extinguishing region being configured to receive the cutoff portion cut off by the projectile, and a coolant material having a fibrous form, the coolant material being disposed in the arc-extinguishing region (for example, Patent Document 1).

### CITATION LIST

### Patent Literature

Patent Document 1: JP 2021-128894 A

### SUMMARY OF INVENTION

### Technical Problem

There has been a problem that a conductor piece is distorted by stress generated in the conductor piece in some cases when a projectile of an electric circuit breaker device cuts the conductor piece. In addition, the deformation of the conductor piece may cause a combustion gas generated by an igniter to leak from the electric circuit breaker device.

It is an object of a technique according to the present disclosure to provide an electric circuit breaker device that reduces deformation of a conductor piece when a projectile cuts the conductor piece.

### Solution to Problem

There is provided an electric circuit breaker device including a housing serving as an outer shell member, the housing configured to enclose an accommodation space extending in one direction, an igniter provided in the housing, a projectile disposed in the housing, the projectile being configured to be projected from one end side of the accommodation space by energy received from the igniter, the projectile being configured to move along an extending direction of the accommodation space, and a conductor piece held by the housing, the conductor piece forming a part of an electric circuit, the conductor piece including a cutoff portion between a first connection end portion as one end portion and a second connection end portion as the other end portion, the cutoff portion being configured to be cut off by movement of the projectile, the cutoff portion being disposed across the accommodation space. The conductor piece includes a deformation suppressing portion configured to suppress deformation when the cutoff portion is cut off by the projectile.

In addition, the deformation suppressing portion may be an extending portion including one end connected to the cutoff portion located in the accommodation space, the extending portion extending in the housing. In addition, the extending portion may include an anchor portion embedded in the housing at the other end of the extending portion. Further, the other end of the extending portion may be connected to the first connection end portion or the second connection end portion.

In addition, the deformation suppressing portion may be a recessed portion or a protruding portion formed at the first connection end portion or the second connection end portion. Further, the recessed portion or the protruding portion may be embedded in the housing. Furthermore, the conductor piece may be a plate-shaped member, and the recessed portion or the protruding portion may be linearly formed at the front side or the rear side of the conductor piece.

### Advantageous Effects of Invention

According to the present disclosure, the electric circuit breaker device that reduces deformation of the conductor piece when the projectile cuts the conductor piece can be provided.

### BRIEF DESCRIPTION OF DRAWINGS

FIG. 1 is a view illustrating an internal structure of an electric circuit breaker device (breaker device) according to an embodiment.

FIG. 2 is a top view of a conductor piece according to a first embodiment.

FIG. 3 is a view illustrating actuation of the breaker device.

FIG. 4 is a top view of a conductor piece according to a second embodiment.

FIG. 5 is a view illustrating a conductor piece according to a third embodiment.

FIG. 6 is a view illustrating a conductor piece according to a fourth embodiment.

### DESCRIPTION OF EMBODIMENTS

### First Embodiment

An electric circuit breaker device according to an embodiment of the present disclosure will be described below with reference to the drawings. Note that the respective configurations, the combinations thereof, and the like in the respective embodiments are only examples, and the configurations may be added, omitted, substituted, or otherwise modified as appropriate within a scope that does not depart from the spirit of the present disclosure. The present disclosure is not limited by the embodiments and is limited only by the claims.

### Configuration

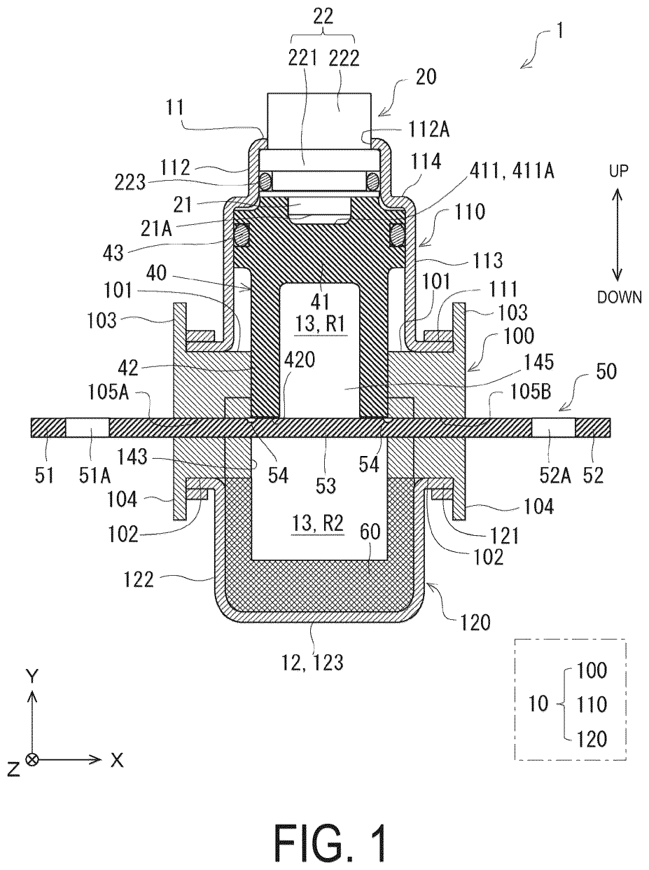

FIG. 1 is a view illustrating an internal structure of an electric circuit breaker device (hereinafter simply referred to as the “breaker device”) 1 according to an embodiment. The breaker device 1 is a device that interrupts an electric circuit when an abnormality occurs in an electric circuit included in a vehicle, an electric home appliance, a photovoltaic system, or the like or in a system including a battery (lithium-ion battery, for example) of the electric circuit, thereby preventing great damage. In the present specification, a cross section along a height direction in FIG. 1 (direction in which an accommodation space 13, which will be described later, extends) is referred to as a vertical cross section of the breaker device 1, and a cross section in a direction orthogonal to the height direction is referred to as a transverse cross section of the breaker device 1. FIG. 1 illustrates a state before actuation of the breaker device 1.

The breaker device 1 includes a housing 10, an igniter 20, a projectile 40, a conductor piece 50, and a coolant material 60. The housing 10 serves as an outer shell member and encloses an accommodation space 13 extending in a direction from a first end portion 11 on an upper end side toward a second end portion 12 on a lower end side. This accommodation space 13 is a space formed in a straight line shape, making the projectile 40 movable, and extends along a vertical direction of the breaker device 1. As illustrated in FIG. 1, the projectile 40 is accommodated on the upper end side in the vertical direction (extending direction) of the accommodation space 13 formed inside the housing 10. In the present specification, the vertical direction is also referred to as a Y-axis direction, a left-right direction is also referred to as an X-axis direction, and a depth direction is also referred to as a Z-axis direction. However, in the present specification, the vertical direction and the XYZ directions of the breaker device 1 merely indicate a relative positional relationship of elements in the breaker device 1 for convenience of description of the embodiment. For example, an orientation at the time of installing the breaker device 1 is not limited to the direction illustrated in the drawing.

### Housing

The housing 10 includes a housing body 100, a top holder 110, and a bottom container 120. The housing body 100 is bonded to the top holder 110 and the bottom container 120, thereby forming the housing 10 that is integral.

The housing body 100 has, for example, a substantially rectangular columnar outer shape. However, the shape of the housing body 100 is not particularly limited. In addition, the housing body 100 includes a cavity portion 145 formed therethrough along the vertical direction. This cavity portion 145 forms a portion of the accommodation space 13. Furthermore, the housing body 100 includes an upper surface 101 to which a flange portion 111 of the top holder 110 is fixed and a lower surface 102 to which a flange portion 121 of the bottom container 120 is fixed. In the present embodiment, an upper tubular wall 103 having a tubular shape is provided, with the upper tubular wall 103 erected upward from the upper surface 101 on an outer circumferential side of the upper surface 101 in the housing body 100. In the present embodiment, the upper tubular wall 103 has a rectangular tubular shape, for example, but may have another shape. On an outer circumferential side of the lower surface 102 in the housing body 100, a lower tubular wall 104 having a tubular shape is provided, with the lower tubular wall 104 suspended downward from the lower surface 102. In the present embodiment, the lower tubular wall 104 has a rectangular tubular shape, for example, but may have another shape. The housing body 100 configured as described above can be formed from an insulating member such as a synthetic resin, for example. For example, the housing body 100 may be formed from nylon, which is a type of polyamide synthetic resin.

### Top Holder

Next, the top holder 110 will be described. The top holder 110 is, for example, a cylindrical member having a stepped circular tubular shape with a cavity inside. The top holder 110 includes a small diameter cylinder portion 112 located on the upper side (first end portion 11 side), a large diameter cylinder portion 113 located on the lower side, a connection portion 114 connecting these, and the flange portion 111 extending outward from a lower end of the large diameter cylinder portion 113. For example, the small diameter cylinder portion 112 and the large diameter cylinder portion 113 are coaxially disposed, and the large diameter cylinder portion 113 has a diameter slightly larger than that of the small diameter cylinder portion 112.

The contour of the flange portion 111 in the top holder 110 has a substantially quadrangular shape that fits inside the upper tubular wall 103 in the housing body 100. For example, the flange portion 111 may be integrally fastened to the upper surface 101 in the housing body 100 by using a screw or the like, or may be fixed thereto by a rivet or the like, in a state of being disposed inside the upper tubular wall 103. Further, the top holder 110 may be bonded to the housing body 100 in a state where a sealant is applied between the upper surface 101 of the housing body 100 and a lower surface of the flange portion 111 in the top holder 110. This can increase airtightness of a tubular space (a portion of the accommodation space 13) formed in the housing 10. Further, instead of the sealant or in combination with the sealant, an O-ring may be interposed between the upper surface 101 of the housing body 100 and the flange portion 111 of the top holder 110 to increase the airtightness of the tubular space.

A cavity portion formed inside the small diameter cylinder portion 112 in the top holder 110 functions as an accommodation space for accommodating a portion of the igniter 20 as illustrated in FIG. 1. Further, a cavity portion formed inside the large diameter cylinder portion 113 in the top holder 110 communicates with a cavity portion of the housing body 100 located below, and forms a portion of the tubular space. The top holder 110 configured as described above can be formed from an appropriate metal member, such as stainless steel or aluminum, having excellent strength and durability, for example. However, a material for forming the top holder 110 is not particularly limited. In addition, for the shape of the top holder 110 as well, the above aspect is an example, and another shape may be adopted.

### Bottom Container

Next, the bottom container 120 will be described. The bottom container 120 has a substantially tubular bottomed shape with a cavity inside, and includes a side wall portion 122, a bottom wall portion 123 connected to a lower end of the side wall portion 122, and the flange portion 121 connected to an upper end of the side wall portion 122. The side wall portion 122 has, for example, a circular tubular shape. The flange portion 121 extends outward from the upper end of the side wall portion 122. The contour of the flange portion 121 in the bottom container 120 has a substantially quadrangular shape that fits inside the lower tubular wall 104 in the housing body 100. For example, the flange portion 121 may be integrally fastened to the lower surface 102 in the housing body 100 by using a screw or the like, or may be fixed thereto by a rivet or the like, in a state of being disposed inside the lower tubular wall 104. Here, the bottom container 120 may be bonded to the housing body 100 in a state where the sealant is applied between the lower surface 102 of the housing body 100 and an upper surface of the flange portion 121 in the bottom container 120. This can increase airtightness of a tubular space (a portion of the accommodation space 13) formed in the housing 10. Further, instead of the sealant or in combination with the sealant, an O-ring may be interposed between the lower surface 102 of the housing body 100 and the flange portion 121 of the bottom container 120 to increase the airtightness of the tubular space.

Note that the above aspect regarding the shape of the bottom container 120 is an example, and another shape may be adopted. Further, the cavity portion formed inside the bottom container 120 communicates with the housing body 100 located above, and forms a portion of the tubular space. The bottom container 120 configured as described above can be formed from an appropriate metal member, such as stainless steel or aluminum, having excellent strength and durability, for example. However, a material for forming the bottom container 120 is not particularly limited. Further, the bottom container 120 may have a multilayer structure. For example, in the bottom container 120, an exterior portion facing the outside may be formed from an appropriate metal member, such as stainless steel or aluminum, having excellent strength and durability, and an interior portion facing the tubular space side may be formed from an insulating member such as a synthetic resin. Of course, the entire bottom container 120 may be formed from an insulating member.

As described above, the housing 10 in the embodiment includes the housing body 100, the top holder 110, and the bottom container 120 that are integrally assembled, and the tubular space extending in the direction from the first end portion 11 to the second end portion 12 is formed inside the housing 10. The tubular space accommodates the igniter 20, the projectile 40, a cutoff portion 53 in the conductor piece 50, the coolant material 60, and the like that will be described below in detail.

### Igniter

Next, the igniter 20 will be described. The igniter 20 is an electric igniter that includes an ignition portion 21 with an ignition charge, and an igniter body 22 including a pair of electro-conductive pins (not illustrated) connected to the ignition portion 21. The igniter body 22 is surrounded by an insulating resin, for example. Further, tip end sides of the pair of electro-conductive pins in the igniter body 22 are exposed to the outside, and are connected to a power source when the breaker device 1 is used.

The igniter body 22 includes a body portion 221 having a substantially circular columnar shape and accommodated inside the small diameter cylinder portion 112 in the top holder 110, and a connector portion 222 located on the body portion 221. The igniter body 22 is fixed to the small diameter cylinder portion 112 by pressing, for example, the body portion 221 into an inner circumferential surface of the small diameter cylinder portion 112. Further, a constricted portion including an outer circumferential surface recessed as compared with other locations is annularly formed along a circumferential direction of the body portion 221 at an axially intermediate portion of the body portion 221. An O-ring 223 is fitted into this constricted portion. The O-ring 223 is formed from, for example, rubber (silicone rubber, for example) or a synthetic resin, and functions to increase airtightness between the inner circumferential surface in the small diameter cylinder portion 112 and the body portion 221.

The connector portion 222 in the igniter 20 is disposed protruding to the outside through an opening 112A formed at an upper end of the small diameter cylinder portion 112. The connector portion 222 has, for example, a circular tubular shape covering sides of the electro-conductive pins, allowing connection with a connector of a power source.

As illustrated in FIG. 1, the ignition portion 21 of the igniter 20 is disposed facing the accommodation space 13 (more specifically, the cavity portion formed inside the large diameter cylinder portion 113) of the housing 10. The ignition portion 21 is configured as a form accommodating an ignition charge in an igniter cup, for example. For example, the ignition charge is accommodated in the igniter cup in the ignition portion 21 in a state of being in contact with a bridge wire (resistor) suspended coupling the base ends of the pair of electro-conductive pins to each other. As the ignition charge, for example, zirconium-potassium perchlorate (ZPP), zirconium-tungsten-potassium perchlorate (ZWPP), titanium hydride-potassium perchlorate (THPP), lead tricinate, or the like may be adopted.

In actuation of the igniter 20, when an actuating current for igniting the ignition charge is supplied from the power source to the electro-conductive pins, the bridge wire in the ignition portion 21 generates heat, and as a result, the ignition charge in the igniter cup is ignited and burns, generating a combustion gas. Then, the pressure in the igniter cup increases along with the combustion of the ignition charge in the igniter cup of the ignition portion 21, a rupture surface 21A of the igniter cup ruptures, and the combustion gas is discharged from the igniter cup into the accommodation space 13. More specifically, the combustion gas from the igniter cup is discharged into a depressed portion 411 in a piston portion 41, which will be described later, of the projectile 40 disposed in the accommodation space 13. Thereby, the projectile 40 is projected downward from an initial position in FIG. 1 along the accommodation space 13.

### Coolant Material

Next, the coolant material 60 disposed in the accommodation space 13 in the housing 10 will be described. Here, as illustrated in FIG. 1, before actuation of the breaker device 1 (igniter 20), the cutoff portion 53 of the conductor piece 50 in a state of being held in a pair of conductor piece holding holes 105A and 105B in the housing body 100 is horizontally laid crossing the accommodation space 13 of the housing 10. Hereinafter, within the accommodation space 13 of the housing 10 separated by the cutoff portion 53 of the conductor piece 50, a region (space) in which the projectile 40 is disposed is referred to as a “projectile initial arrangement region R1”, and a region (space) located on the opposite side of the projectile 40 is referred to as an “arc-extinguishing region R2”. Note that since a gap is formed on the side in the depth direction (Z-axis direction) of the cutoff portion 53 disposed across the accommodation space 13, the projectile initial arrangement region R1 and the arc-extinguishing region R2 are not completely isolated from each other by the cutoff portion 53, but communicate with each other. Of course, depending on the shape and size of the cutoff portion 53, the projectile initial arrangement region R1 and the arc-extinguishing region R2 may be completely isolated from each other by the cutoff portion 53.

The arc-extinguishing region R2 of the accommodation space 13 is a region (space) for receiving the cutoff portion 53 cut off by a rod portion 42 of the projectile 40 projected during actuation of the breaker device 1 (igniter 20). In this arc-extinguishing region R2, the coolant material 60 as an arc-extinguishing material is disposed. The coolant material 60 has a substantially tubular bottomed shape, and is disposed along and inside the side wall portion 122 and the bottom wall portion 123 of the bottom container 120. The coolant material 60 is a coolant material for removing thermal energy of the cutoff portion 53 and the arc generated when the projectile 40 cuts off the cutoff portion 53 of the conductor piece 50, and cooling the arc and the cutoff portion 53, thereby suppressing arc generation during interruption of a current or thereby extinguishing (eliminating) the generated arc.

The arc-extinguishing region R2 in the breaker device 1 is a space for receiving the cutoff portion 53 cut off from a first connection end portion 51 and a second connection end portion 52 of the conductor piece 50 by the projectile 40, and at the same time, has a significance as a space for effectively extinguishing the arc generated when the projectile 40 cuts off the cutoff portion 53. Then, the coolant material 60 is disposed as an arc-extinguishing material in the arc-extinguishing region R2, thereby effectively extinguishing the arc generated when the cutoff portion 53 is cut off from the conductor piece 50.

As one aspect of the embodiment, the coolant material 60 is solid. As one aspect of the embodiment, the coolant material 60 is formed from a shape retaining body. The shape retaining body herein is, for example, a material that can keep a certain shape when no external force is applied and can hold the integrity (does not come apart), even if deformation can occur, when an external force is applied. For example, examples of the shape retaining body include a fibrous body formed into a desired shape. In the present embodiment, the coolant material 60 is formed from a metal fiber that is a shape retaining body. Here, examples of the metal fiber forming the coolant material 60 include an aspect in which at least any one of steel wool or copper wool is included. However, the above aspect in the coolant material 60 is an example, and the coolant material 60 is not limited to the above aspect.

### Projectile

Next, the projectile 40 will be described. The projectile 40 is formed from an insulating member such as a synthetic resin, for example, and includes the piston portion 41 and the rod portion 42 connected to the piston portion 41. The piston portion 41 has a substantially circular columnar shape and has an outer diameter substantially corresponding to an inner diameter of the large diameter cylinder portion 113 in the top holder 110. For example, a diameter of the piston portion 41 may be slightly smaller than the inner diameter of the large diameter cylinder portion 113. The piston portion 41 has the outer diameter larger than a diameter of the cavity portion 145 in the housing body 100, and is configured not to enter the cavity portion 145 but to strike against a peripheral member forming the cavity portion 145. That is, the piston portion 41 is formed with a transverse cross-sectional area orthogonal to a movement direction (an axis direction) on a tip end side connected to the rod portion 42 being larger than a transverse cross-sectional area on the rear end side of the rod portion 42 and a transverse cross-sectional area of the cavity portion 145. The shape of the projectile 40 can be changed as appropriate in accordance with the shape of the housing 10 and the like.

Further, the depressed portion 411 having a circular columnar shape, for example, is formed at an upper surface of the piston portion 41. This depressed portion 411 receives the ignition portion 21. A bottom surface of the depressed portion 411 is formed as a pressure receiving surface 411A that receives energy pressure received from the igniter 20 during actuation of the igniter 20. Further, a constricted portion including an outer circumferential surface recessed as compared with other locations is annularly formed along a circumferential direction of the piston portion 41 at an axially intermediate portion of the piston portion 41. An O-ring 43 is fitted into this constricted portion. The O-ring 43 is formed from, for example, rubber (silicone rubber, for example) or a synthetic resin, and functions to increase airtightness between an inner circumferential surface in the large diameter cylinder portion 113 and the piston portion 41.

The rod portion 42 of the projectile 40 is a rod-shaped member having an outer circumferential surface smaller in diameter than the piston portion 41 and extending along the extending direction of the accommodation space 13, for example, and is integrally connected to a lower end side of the piston portion 41. When the igniter 20 is actuated, the rod portion 42 moves along the extending direction of the accommodation space 13 and is inserted into the cavity portion 145 of the housing body 100. A lower end surface of the rod portion 42 is formed as a cutoff surface 420 for cutting off the cutoff portion 53 from the conductor piece 50 during actuation of the breaker device 1. Note that although the rod portion 42 in the present embodiment has a substantially circular tubular shape, the shape thereof is not particularly limited, and can be changed in accordance with the shape and size of the cutoff portion 53 to be cut off from the conductor piece 50 during actuation of the breaker device 1. The rod portion 42 may have a columnar shape such as a circular column, an elliptic column, or a rectangular column, for example. Note that, at the initial position of the projectile 40 illustrated in FIG. 1, a region on the tip end side including the cutoff surface 420 in the rod portion 42 of the projectile 40 is disposed above the cavity portion (a holding region) 145 of the housing body 100.

In the projectile 40 configured as described above, the projectile 40 is projected from the initial position illustrated in FIG. 1 when the upper surface of the piston portion 41 including the pressure receiving surface 411A receives the energy pressure from the igniter 20 during actuation of the igniter 20, and moves at high speed toward the second end portion 12 side (downward) along the accommodation space 13. Specifically, as illustrated in FIG. 1, the piston portion 41 of the projectile 40 is accommodated inside the large diameter cylinder portion 113 in the top holder 110, and is slidable in the axis direction along an inner wall surface of the large diameter cylinder portion 113. The projectile 40 after being projected is stopped when a lower end surface of the piston portion 41 comes into contact with (collides with) the upper surface 101 of the housing body 100. That is, the rod portion 42 is fitted into the cavity portion 145 up to a rear end 421. In the present embodiment, the piston portion 41 of the projectile 40 has a substantially circular columnar shape, but the shape thereof is not particularly limited. As the outer shape of the piston portion 41, an appropriate shape and size can be adopted in accordance with the shape and size of the inner wall surface of the large diameter cylinder portion 113.

### Conductor Piece

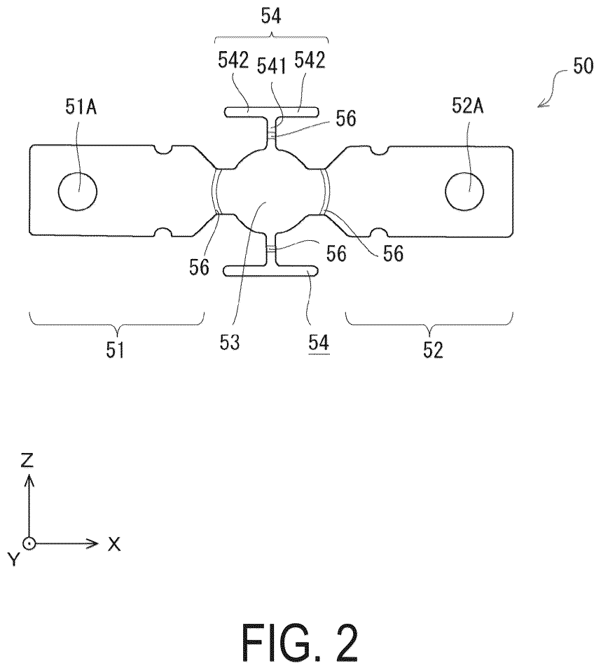

Next, the conductor piece 50 will be described. FIG. 2 is a top view of the conductor piece 50 according to the embodiment. The conductor piece 50 is a metal body having conductivity that constitutes one or some of the components of the breaker device 1 and, when the breaker device 1 is attached to a predetermined electric circuit, the conductor piece 50 forms a portion of the electric circuit, and may be referred to as a bus bar. Additionally, the conductor piece 50 and the housing body 100 are integrally formed. The conductor piece 50 is held by the housing body 100 and disposed across the cavity portion 145 in the housing body. In the present embodiment, a region (cavity portion 145) defined by an inner wall of the housing body 100 holding the conductor piece 50 in this way serves as a holding region.

The conductor piece 50 can be formed from a metal such as copper (Cu), for example. However, the conductor piece 50 may be formed from a metal other than copper, or may be formed from an alloy of copper and another metal. Note that examples of the metal other than copper included in the conductor piece 50 include manganese (Mn), nickel (Ni), and platinum (Pt).

In one aspect illustrated in FIG. 2, the conductor piece 50 is formed as an elongated flat plate piece as a whole, and includes the first connection end portion 51 and the second connection end portion 52 on both end sides, and the cutoff portion 53 located in an intermediate portion of the first connection end portion 51 and the second connection end portion 52. In addition, the cutoff portion 53 has a substantially circular shape, and a width (length in the Z-axis direction) of each of the first connection end portion 51 and the second connection end portion 52 on the cutoff portion 53 side gradually decreases. The first connection end portion 51 and the second connection end portion 52 of the conductor piece 50 are provided with connection holes 51A and 52A, respectively. These connection holes 51A and 52A are used to connect with other conductors (lead wires, for example) in the electric circuit. Further, the conductor piece 50 includes two deformation suppressing portions 54 that suppress deformation of the conductor piece 50 when the conductor piece 50 is cut by the projectile 40. The deformation suppressing portion 54 in the present embodiment is a T-shaped portion protruding from the cutoff portion 53.

The cutoff portion 53 of the conductor piece 50 is a site that is forcibly and physically cut by the rod portion 42 of the projectile 40 and thus cut off from the first connection end portion 51 and the second connection end portion 52, when an abnormality such as an excessive current occurs in the electric circuit to which the breaker device 1 is applied. Recessed portions (slits) 56 are formed at peripheral edges of the cutoff portion 53 (that is, between the cutoff portion 53 and the first connection end portion 51, between the cutoff portion 53 and the second connection end portion 52, and between the cutoff portion 53 and the deformation suppressing portion 54), and thus the cutoff portion 53 is easily cut. Then, the conductor piece 50 is cut at a position overlapping an inside surface (inner wall surface) of an inner wall 143 (FIG. 1) defining the cavity portion 145 of the housing body 100, that is, at a position overlapping the outer circumferential surface of the rod portion 42, and thus the cutoff portion 53 is cut off.

In the present embodiment, the deformation suppressing portion 54 includes an elongated portion 541 elongated from the cutoff portion 53 in a corresponding one of a third direction and a fourth direction (Z-axis direction) perpendicular to a first direction in which the first connection end portion 51 is located with respect to the cutoff portion 53 and a second direction in which the second connection end portion 52 is located with respect to the cutoff portion 53 (the X-axis direction), and an anchor portion 542 bent and extending from a tip of the elongated portion 541 in the first direction and the second direction. The anchor portion 542 is embedded in the housing body 100 integrally formed with the conductor piece 50. Moreover, the anchor portion 542 resists a force applied in a manner to pull out the deformation suppressing portion 54 in the direction of the cutoff portion 53 when the cutoff portion 53 is cut by the projectile 40, and disperses forces to deform both end portions (the first connection end portion 51, the second connection end portion 52, and the deformation suppressing portion 54) of the conductor piece 50 upward as the cutoff portion 53 deforms downward with the recessed portion 56 as a fulcrum, thereby suppressing the deformation of both the end portions of the conductor piece 50.

Here, the conductor piece 50 is not limited to the example of FIG. 2. For example, in the conductor piece 50, the cutoff portion 53 may be connected to the first connection end portion 51 and the second connection end portion 52 in an orthogonal or inclined orientation. Further, the planar shape of the cutoff portion 53 of the conductor piece 50 is not particularly limited, either. Of course, the shapes of the first connection end portion 51 and the second connection end portion 52 in the conductor piece 50 are also not particularly limited. Further, the recessed portion 56 in the conductor piece 50 may be omitted.

### Operation

Next, operation content when the breaker device 1 is actuated to interrupt the electric circuit will be described. As described above, FIG. 1 illustrates a state of the breaker device 1 before actuation (hereinafter also referred to as a “pre-actuation initial state”). In this pre-actuation initial state, in the projectile 40 in the breaker device 1, the piston portion 41 is located on the first end portion 11 side (upper end side) in the accommodation space 13, and the cutoff surface 420 formed at a lower end of the rod portion 42 is set at an initial position determined on an upper surface of the cutoff portion 53 in the conductor piece 50.

Furthermore, the breaker device 1 according to the embodiment further includes an abnormality detection sensor (not illustrated) that detects an abnormal state of a device (such as a vehicle, a power generation facility, or a power storage facility) to which an electric circuit to be interrupted is connected, and a control unit (not illustrated) that controls the actuation of the igniter 20. In addition to the current flowing through the conductor piece 50, the abnormality detection sensor may be able to detect an abnormal state on the basis of a voltage or a temperature of the conductor piece 50. Further, the abnormality detection sensor may be, for example, an impact sensor, a temperature sensor, an acceleration sensor, a vibration sensor, or the like, and may detect an abnormal state such as an accident or fire on the basis of an impact, a temperature, an acceleration, or a vibration in a device such as a vehicle. The control unit of the breaker device 1 is a computer capable of performing a predetermined function by executing a predetermined control program, for example. The predetermined function of the control unit may be achieved by corresponding hardware. Then, when an excessive current flows through the conductor piece 50 forming a portion of the electric circuit to which the breaker device 1 is applied, the abnormal current is detected by the abnormality detection sensor. Abnormality information regarding the detected abnormal current is passed from the abnormality detection sensor to the control unit. For example, the control unit is energized from an external power source (not illustrated) connected to the electro-conductive pins of the igniter 20 and actuates the igniter 20 based on the current value detected by the abnormality detection sensor. Here, the abnormal current may be a current value that exceeds a predetermined threshold value set for protection of a predetermined electric circuit. Note that the abnormality detection sensor and the control unit described above need not be included in the components of the breaker device 1, and may be included in a device separately from the breaker device 1, for example. Further, the abnormality detection sensor and the control unit are not essential components of the breaker device 1.

For example, when an abnormal current of the electric circuit is detected by the abnormality detection sensor that detects an abnormal current of the electric circuit, the control unit of the breaker device 1 actuates the igniter 20. That is, an actuating current is supplied from the external power source (not illustrated) to the electro-conductive pins of the igniter 20, and as a result, the ignition charge in the ignition portion 21 is ignited and burns, generating a combustion gas. Then, the rupture surface 21A ruptures due to a rise in pressure in the ignition portion 21, and the combustion gas of the ignition charge is discharged from the inside of the ignition portion 21 into the accommodation space 13.

Here, the ignition portion 21 of the igniter 20 is received in the depressed portion 411 of the piston portion 41, and the rupture surface 21A of the ignition portion 21 is disposed facing the pressure receiving surface 411A of the depressed portion 411 in the projectile 40. Therefore, the combustion gas from the ignition portion 21 is discharged to the depressed portion 411, and the pressure (combustion energy) of the combustion gas is transmitted to the upper surface of the piston portion 41 including the pressure receiving surface 411A. As a result, the projectile 40 moves downward along the accommodation space 13 in the extending direction (axis direction) of the accommodation space 13.

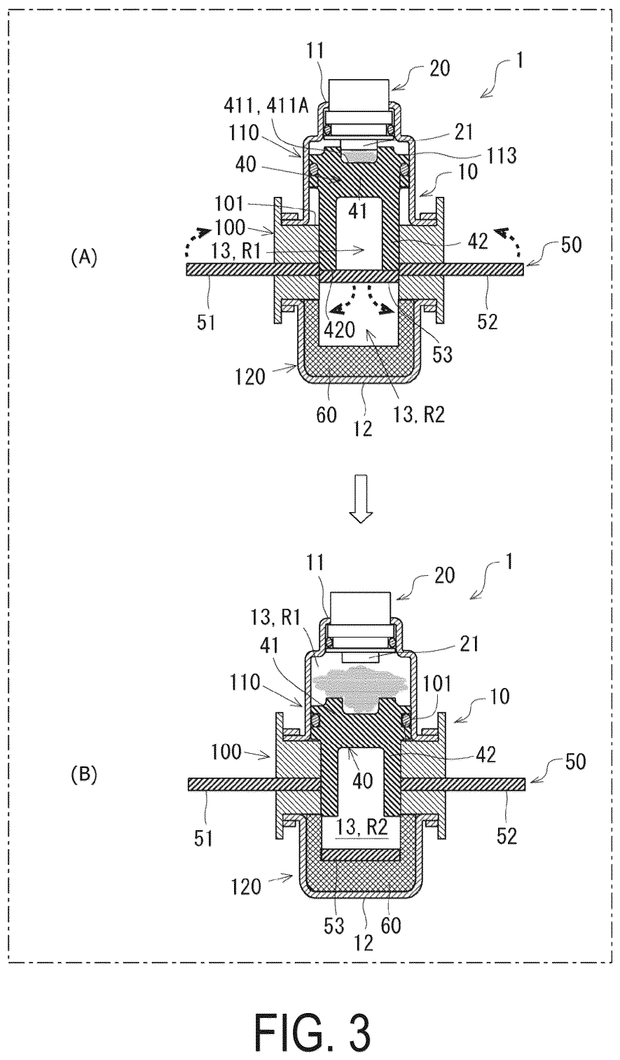

FIG. 3 is a view illustrating an actuation situation of the breaker device 1 according to the embodiment. (A) in the upper portion of FIG. 3 illustrates a situation in the middle of actuation of the breaker device 1, and (B) in the lower portion of FIG. 3 illustrates a situation in which the actuation of the breaker device 1 is completed. As described above, by the actuation of the igniter 20, the projectile 40 having received the pressure (combustion energy) of the combustion gas of the ignition charge is pushed downward vigorously, and as a result, the cutoff surface 420 formed on the lower end side of the rod portion 42 pushes and cuts, by shearing, boundary portions between the cutoff portion 53 and each of the first connection end portion 51 and the second connection end portion 52 of the conductor piece 50. At this time, the projectile 40 and the lower portion of the housing body 100 generate a bending moment in the conductor piece 50, as indicated by an arrow illustrated with a broken line. Note that when a clearance between the projectile 40 and the housing body 100 is increased in size, the distortion of the conductor piece 50 is increased. As long as the projectile 40 can be moved smoothly in the extending direction (axis direction) of the accommodation space 13 when the igniter 20 is actuated, the shape and the dimensions of the projectile 40 can be freely determined, and the outer diameter of the piston portion 41 in the projectile 40 may be set to a dimension equal to the inner diameter of the large diameter cylinder portion 113 in the top holder 110, for example.

Then, as illustrated in the lower half of FIG. 3, the projectile 40 moves downward along the extending direction (axis direction) of the accommodation space 13 by a predetermined stroke until the lower end surface of the piston portion 41 abuts on (collides with) the upper surface 101 of the housing body 100. In this state, the cutoff portion 53, which has been cut off from the conductor piece 50 by the rod portion 42 of the projectile 40, is received in the arc-extinguishing region R2 where the coolant material 60 is disposed. As a result, the first connection end portion 51 and the second connection end portion 52 individually located at both ends of the conductor piece 50 are brought into an electrically disconnected state, and a predetermined electric circuit to which the breaker device 1 is applied is forcibly interrupted.

### Effects of Embodiment

In the breaker device 1 according to the embodiment, the anchor portion 542 integrally formed with the conductor piece 50 and embedded in the housing body 100 resists a force applied in a manner to pull out the deformation suppressing portion 54 in the direction of the cutoff portion 53 when the cutoff portion 53 is cut by the projectile 40. In addition, when the cutoff portion 53 is deformed downward, the anchor portion 542 disperses forces that cause the end portions (the first connection end portion 51, the second connection end portion 52, and the deformation suppressing portion 54) of the conductor piece 50 to be distorted upward with the recessed portion 56 as a fulcrum, thereby suppressing the deformation.

### Second Embodiment

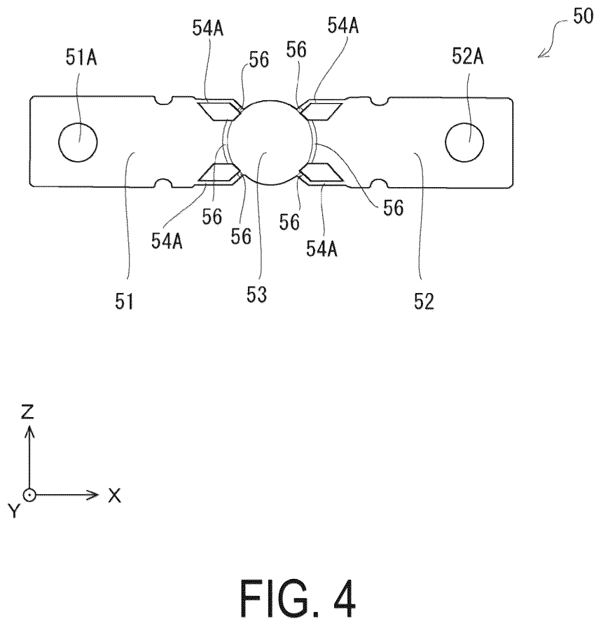

FIG. 4 is a top view of a conductor piece according to a second embodiment. Note that components corresponding to the components in the first embodiment described above are given the identical reference signs, and the description will be omitted.

As compared with the first embodiment described above, the conductor piece 50 according to the present embodiment includes four deformation suppressing portions 54A extending in four directions in an X-shape in a plan view, and the four deformation suppressing portions 54A are individually connected to the vicinities of both ends of the first connection end portion 51 in the width direction (Z-axis direction) and the vicinities of both ends of the second connection end portion 52 in the width direction (Z-axis direction). In other words, the first connection end portion 51 and the second connection end portion 52 include four connection portions with a reduced width on the sides of the cutoff portion 53. Further, the connection portions at both the ends in the width direction added in the present embodiment are referred to as the deformation suppressing portions 54A. The deformation suppressing portions 54A are also embedded in the housing body 100 integrally formed with the conductor piece 50. Then, when the cutoff portion 53 is cut by the projectile 40, the deformation suppressing portions 54A disperse forces that cause both the end portions (the first connection end portion 51 and the second connection end portion 52) of the conductor piece 50 to be distorted upward as the cutoff portion 53 is deformed downward with the recessed portion 56 as a fulcrum, thereby suppressing the deformation of both the end portions of the conductor piece 50.

As illustrated in the first embodiment and the second embodiment, the deformation suppressing portion may be an extending portion including one end connected to the cutoff portion and extending into the housing body 100.

### Third Embodiment

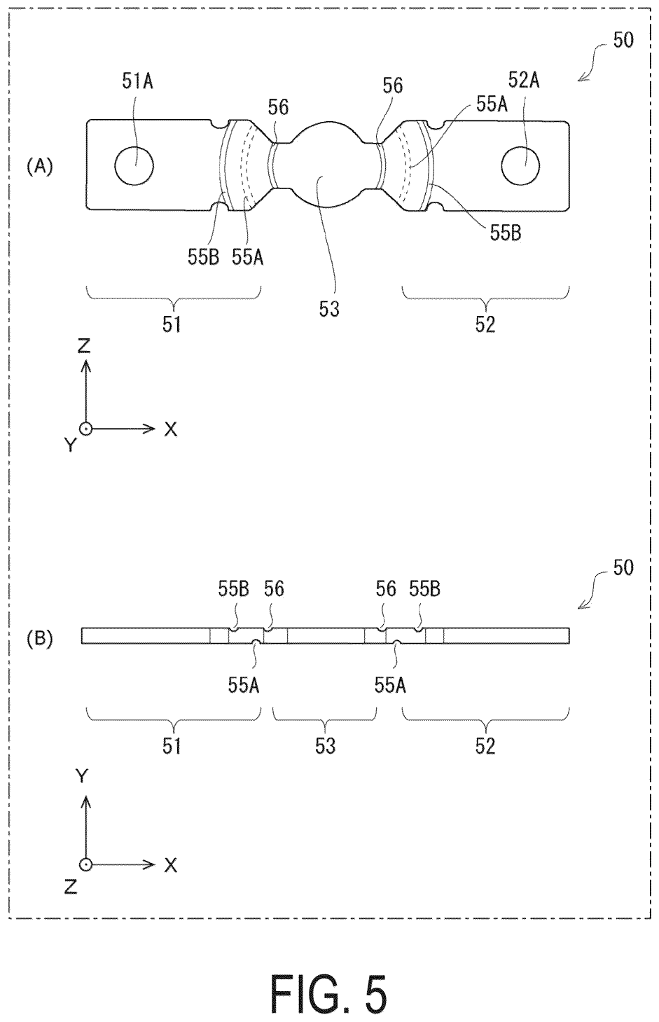

FIG. 5 is a view illustrating a conductor piece according to a third embodiment. (A) of the upper portion is a top view of the conductor piece 50, and (B) of the lower portion is a front view of the conductor piece 50. Note that components corresponding to the components in the first embodiment or the second embodiment described above are given the identical reference signs, and the description will be omitted.

The conductor piece 50 according to the present embodiment includes a deformation suppressing portion 55A having an arc shape concentric with the cutoff portion 53 on a bottom surface side of each of the first connection end portion 51 and the second connection end portion 52. In addition, the conductor piece 50 includes a deformation suppressing portion 55B having an arc shape concentric with the cutoff portion 53 on an upper surface side of each of the first connection end portion 51 and the second connection end portion 52. Each of the deformation suppressing portion 55A and the deformation suppressing portion 55B is a recessed portion (slit). In addition, a radius of an arc of the deformation suppressing portion 55B is larger than that of the deformation suppressing portion 55A. Therefore, the recessed portion 56 formed at an outer edge of the cutoff portion 53, the deformation suppressing portion 55A, and the deformation suppressing portion 55B constitute recessed portions alternately provided on an upper surface and a bottom surface of the conductor piece 50. The deformation suppressing portion 55A and the deformation suppressing portion 55B are embedded in the housing body 100 integrally formed with the conductor piece 50. Then, connection portions between the deformation suppressing portion 55A and the deformation suppressing portion 55B and the housing body 100 resist forces that cause both the end portions (the first connection end portion 51 and the second connection end portion 52) of the conductor piece 50 to be deformed upward as the cutoff portion 53 is deformed downward with the recessed portion 56 as a fulcrum when the cutoff portion 53 is cut by the projectile 40. Therefore, when the cutoff portion 53 is cut by the projectile 40, the size of a gap generated between the conductor piece 50 and the housing body 100 can be reduced. Further, by forming a boundary between the conductor piece 50 and the housing body 100 in a meandering shape like a so-called labyrinth structure to increase a surface area of the boundary, leakage of a combustion gas from the breaker device 1 can be suppressed even if a gap is generated between the conductor piece 50 and the housing body 100 when the cutoff portion 53 is cut by the projectile 40.

Note that the number of each of the deformation suppressing portions 55A and 55B is not limited to two. In addition, the deformation suppressing portions 55A and 55B do not necessarily need to be alternately provided on the upper surface and the bottom surface of the conductor piece 50, and may be provided at corresponding positions on the upper surface and the bottom surface in a manner to overlap each other in a plan view.

### Fourth Embodiment

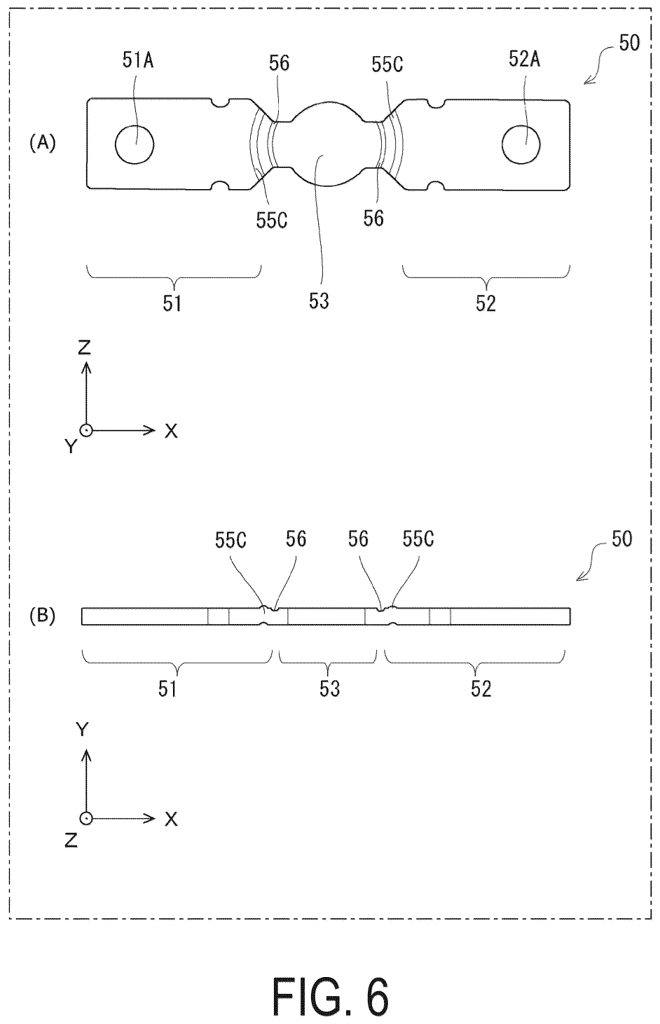

FIG. 6 is a view illustrating a conductor piece according to a fourth embodiment. (A) of the upper portion is a top view of the conductor piece 50, and (B) of the lower portion is a front view of the conductor piece 50. Note that components corresponding to the components in the first embodiment to the third embodiment described above are given the identical reference signs, and the description will be omitted.

The conductor piece 50 according to the present embodiment includes, on the upper surface side of each of the first connection end portion 51 and the second connection end portion 52, a deformation suppressing portion 55C having a bow-shaped cross section in which an upper surface is formed in a protruding shape and a bottom surface is formed in a recessed shape. The deformation suppressing portion 55C also has an arc shape concentric with the cutoff portion 53, and is provided outside the cutoff portion 53. Therefore, when the cutoff portion 53 is cut by the projectile 40, the deformation suppressing portion 55C also resists a force that causes each of both the end portions (the first connection end portion 51 and the second connection end portion 52) of the conductor piece 50 to be deformed upward as the cutoff portion 53 is deformed downward with the recessed portion 56 as a fulcrum. Therefore, when the cutoff portion 53 is cut by the projectile 40, the size of a gap generated between the conductor piece 50 and the housing body 100 can be reduced. In addition, a boundary between the conductor piece 50 and the housing body 100 is formed in a meandering shape like a so-called labyrinth structure, and when the cutoff portion 53 is cut by the projectile 40, even if a gap is generated between the conductor piece 50 and the housing body 100, leakage of a combustion gas from the breaker device 1 can be suppressed.

Note that the deformation suppressing portion 55C having the bow shape may be configured to protrude to a rear side (bottom surface side) of the conductor piece 50. Further, a plurality of deformation suppressing portions 55C may be provided on the upper surface side or the bottom surface side of the conductor piece 50.

As illustrated in the third embodiment and the fourth embodiment, the deformation suppressing portion may be a recess and a protrusion formed at the first connection end portion 51 or the second connection end portion 52. Note that the recess and the protrusion may be a recessed portion or a protruding portion formed at the front side or the rear side of the conductor piece 50 having a plate shape, and may be formed in a linear shape (for example, a curved line shape or a straight line shape).

### Other

Each aspect disclosed in the present specification can be combined with any other feature disclosed herein. For example, two or more of the deformation suppressing portion 54 of the first embodiment, the deformation suppressing portion 54A of the second embodiment, the deformation suppressing portions 55A and 55B of the third embodiment, and the deformation suppressing portion 55C of the fourth embodiment may be implemented in combination. Further, the configuration may be changed without departing from the gist of the present disclosure. For example, the shape of the anchor portion 542 is not limited to that illustrated in FIG. 2, and the anchor portion 542 does not need to be provided. In addition, as long as at least a part of the deformation suppressing portion 54 described above is embedded in the housing body 100, the deformation suppressing portion 54 may be exposed to the outside of the housing 10.

### REFERENCE SIGNS LIST

1: Breaker device
10: Housing
13: Accommodation space
20: Igniter
40: Projectile
50: Conductor piece
51: First connection end portion
52: Second connection end portion
53: Cutoff portion
54, 55: Deformation suppressing portion
60: Coolant material

1. An electric circuit breaker device comprising:
a housing serving as an outer shell member, the housing configured to enclose an accommodation space extending in one direction;
an igniter provided in the housing;
a projectile disposed in the housing, the projectile being configured to be projected from one end side of the accommodation space by energy received from the igniter, the projectile being configured to move along an extending direction of the accommodation space; and
a conductor piece held by the housing, the conductor piece forming a part of an electric circuit, the conductor piece including a cutoff portion between a first connection end portion as one end portion and a second connection end portion as the other end portion, the cutoff portion being configured to be cut off by movement of the projectile, the cutoff portion being disposed across the accommodation space, wherein
the conductor piece includes a deformation suppressing portion configured to suppress deformation when the cutoff portion is cut off by the projectile.

2. The electric circuit breaker device according to claim 1, wherein
the deformation suppressing portion is an extending portion including one end connected to the cutoff portion located in the accommodation space, the extending portion extending in the housing.

3. The electric circuit breaker device according to claim 2, wherein
the extending portion includes an anchor portion embedded in the housing at the other end of the extending portion.

4. The electric circuit breaker device according to claim 2, wherein
the other end of the extending portion is connected to the first connection end portion or the second connection end portion.

5. The electric circuit breaker device according to claim 1, wherein
the deformation suppressing portion is a recessed portion or a protruding portion formed at the first connection end portion or the second connection end portion.

6. The electric circuit breaker device according to claim 5, wherein
the recessed portion or the protruding portion is embedded in the housing.
